(19) United States
(12) Patent Application Publication
(10) Pub. No.: US 2026/0201845 A1
(43) Pub. Date: Jul. 16, 2026

(54) METHOD OF RESTRICTING ROTATIONAL SPEED OF AN ENGINE OF A HANDHELD POWER TOOL, CONTROL ARRANGEMENT, AND HANDHELD POWER TOOL

(71) Applicant: HUSQVARNA AB, Huskvarna (SE)

(72) Inventors: Mikael LARSSON, Huskvarna (SE); Bo ANDREASSON, Huskvarna (SE)

(21) Appl. No.: 19/135,413

(22) PCT Filed: Nov. 10, 2023
(86) PCT No.: PCT/SE2023/051145

§ 371 Date: Jun. 4, 2025

(30) Foreign Application Priority Data
Dec. 5, 2022 (SE) 2251418-6

(51) Int. Cl. F02D 9/02; F02P 5/04

(52) U.S. Cl. CPC F02D 9/02; F02P 5/045; F02D 2009/0208; F02D 2009/0213; F02D 2009/023; F02D 2200/101

(57) ABSTRACT

A method (100) of restricting a rotational speed of a crankshaft (3) of an engine (10) of a handheld power tool (1). The engine (10) comprises an ignition device (7), an air inlet system (9), a throttle valve (11) in the air inlet system (9), and an electric actuator arrangement (13) configured to move the throttle valve (11) between an open position and a closed position. The method (100) comprises the steps of, when the rotational speed of the crankshaft (3) reaches above an upper threshold speed: retarding (110) an ignition timing of the ignition device (7) from an initial ignition timing to a retarded ignition timing, and controlling (120) the electric actuator arrangement (13) to move the throttle valve (11) towards the closed position. The present disclosure further relates to a control arrangement (21) and a handheld power tool (1).

### TECHNICAL FIELD

The present disclosure relates to a method of restricting a rotational speed of a crankshaft of an internal combustion engine of a handheld power tool. The present disclosure further relates to a control arrangement configured to restrict the rotational speed of a crankshaft of an internal combustion engine of a handheld power tool and a handheld power tool comprising an internal combustion engine.

### BACKGROUND

Internal combustion engines, such as four-stroke internal combustion engines and two-stroke internal combustion engines, are used in some handheld power tools for powering a tool of the handheld power tool. Typical examples of such handheld power tools are chainsaws, power cutters, hedge trimmers, leaf blowers, multi-tools, or the like.

Internal combustion engines for handheld power tools normally comprises a cylinder, a piston arranged in the cylinder, a crankshaft, and a connecting rod connecting the piston to the crankshaft such that the piston reciprocates in the cylinder upon rotation of the crankshaft.

The uppermost position of the piston in the cylinder is usually referred to as the top dead centre TDC and the lowermost position of the piston in the cylinder is usually referred to as the bottom dead centre BDC.

Moreover, two-stroke and four-stroke engines of Otto-type comprise an ignition device, such as a spark plug, configured to ignite an air/fuel mixture in the cylinder. The air/fuel mixture is normally ignited when the piston is in a region of the top dead centre TDC, such as a number of crank angle degrees before or after the top dead centre TDC depending on the operational conditions of the engine. However, in most engines and in most operational conditions, the air/fuel mixture is ignited a number of crank angle degrees before the top dead centre TDC in order to optimize the fuel efficiency and the power output of the engine.

A two-stroke engine is a type of internal combustion engine which completes a power cycle with two strokes of the piston during only one crankshaft revolution. Compared to four-stroke engines, two-stroke engines have a greatly reduced number of moving parts, and consequently can be made more compact and significantly lighter. Therefore, two-stroke petrol engines are normally used in applications where mechanical simplicity, light-weight, and high power-to-weight ratio are main concerns.

Most small sized two-stroke engines are crankcase-scavenged engines meaning that these engines use the area below the piston as a charging pump to build up pressure in the crankcase during the power stroke of the piston. Normally, crankcase scavenged two-stroke engines comprise an air inlet connected to the crankcase, wherein air, or an air/fuel mixture, is sucked into the crankcase upon movement of the piston towards the top dead centre. Traditionally, two-stroke engines have been provided with a carburettor arranged at the air inlet for supplying an air/fuel mixture to the crankcase.

In the power stroke of a two-stroke engine, the increased pressure and temperature in the cylinder obtained by the combustion of fuel is partially converted into mechanical work supplied to a crankshaft of the engine. At the same time, the pressure in the crankcase increases as a result of the movement of the piston towards the bottom dead centre.

An exhaust port arranged in the cylinder wall is opened to allow exhaust gases to flow out from the cylinder when the piston reaches a first position relative to the cylinder in its movement towards the bottom dead centre. The piston continues the movement towards the bottom dead centre and when it reaches a second position, below the first position, an inlet port arranged in the cylinder wall is opened. The inlet port is fluidly connected to the crankcase via a scavenging channel. The air/fuel mixture in the crankcase is forced to flow into the cylinder via the inlet port by the overpressure in the crankcase. Accordingly, as understood from the above, in this type of engine, the exhaust port, and the inlet port in the cylinder are open simultaneously in the scavenging phase of the engine, i.e., when the piston is in the region of a bottom dead centre.

A four-stroke internal combustion engine completes four separate strokes while turning a crankshaft two crankshaft revolutions. A stroke refers to the full travel of the piston along the cylinder, in either direction. The strokes are completed in the following order, inlet stroke, compression stroke, expansion stroke and exhaust stroke. Four-stroke internal combustion engines normally comprises one or more inlet valves and outlet valves as well as one or more fuel supply arrangements. The one or more inlet valves and outlet valves are controlled by a respective valve control arrangement usually comprising one or more camshafts rotatably connected to a crankshaft of the engine, via a belt, chain, gears, or similar.

During operation of a conventional four-stroke internal combustion engine, the inlet valve control arrangement controls inlet valves of a cylinder to an open position during the inlet stroke of a piston within the cylinder, to allow air, or a mixture of air and fuel, to enter the cylinder. During the compression stroke, all valves should be closed to allow compression of the air, or the mixture of the air and fuel, in the cylinder. If the engine is in a power producing position, fuel in the cylinder is ignited, usually towards the end of the compression stroke, for example by a spark plug. The combustion of fuel within the cylinder significantly increases pressure and temperature in the cylinder. The combustion of the fuel usually continues into a significant portion of the subsequent expansion stroke. The increased pressure and temperature in the cylinder obtained by the combustion is partially converted into mechanical work supplied to the crank shaft during the expansion stroke.

Obviously, all valves should remain closed during the expansion stroke to allow the increased pressure and temperature to be converted into mechanical work. The expansion stroke is also usually referred to as the combustion stroke, since usually, most of the combustion takes place during the expansion stroke. In the subsequent exhaust stroke, the exhaust valve control arrangement controls exhaust valves of the cylinder to an open position to allow exhaust gases to be expelled out of the cylinder into an exhaust system of the combustion engine.

Internal combustion engines of handheld power tools are normally optimized to operate at relatively high rotational speeds. One reason for this is that higher rotational speeds allow for a high power output of the engine given the displacement and the weight of the engine.

A low weight of an engine of a handheld power tool is preferred because the weight of the power tool puts strain to hands, arms, and back of a user. Moreover, a low weight can allow users to operate the handheld power tool in a safer manner.

The rotational speed of a crankshaft of an internal combustion engine must normally be restricted to ensure durability of the engine. The restriction is normally initiated when the rotational speed of the crankshaft reaches an upper threshold speed.

Internal combustion engines of handheld power tools are normally optimized for fast acceleration. Moreover, during a work session with a handheld power tool, the engine can be operated at operation speeds close to an upper threshold speed. When a user removes the tool from an object currently being processed, the resistance torque that the engine faces is quickly removed, and if so, the rotational speed of the engine tends to rapidly increase above the upper threshold speed.

The combination of these facts, i.e., that engines of handheld power tools are normally optimized for operation at high rotational speeds, are optimized for fast acceleration, and that the resistance torque can be quickly removed, the upper threshold speed of the engine can be passed several times during a work session with a handheld power tool.

A common way of restricting the rotational speed of a crankshaft of an engine of a handheld power tool is to control the ignition device of the engine to skip ignition events of the air/fuel mixture in the cylinder when the rotational speed of the crankshaft reaches an upper threshold speed. This solution is a simple and cost-effective way of restricting the rotational speed of the crankshaft. However, it is also associated with some problems and drawbacks. One problem is that it causes unwanted fuel consumption and emission levels from the engine. This is because the lack of combustion of the fuel added to the cylinder resulting from the skipping of ignition events causes high amounts of unburnt fuel supplied to an exhaust system of the engine.

Such high amounts of unburnt fuel add to the fuel consumption of the engine and have a negative impact on the environment, as well as on people and animals in the vicinity of the handheld power tool. Moreover, the high amounts of unburnt fuel can also cause problems in using an exhaust aftertreatment system, such as a catalytic converter, on the engine.

Another problem is that the durability of the engine can be impaired when using the above described solution for restricting the rotational speed of the crankshaft. This is caused by the fact that excessively large and intensive combustion events can occur when resuming the ignition of air/fuel mixture after the skipping of the ignition events. Such excessively large and intensive combustions can put strain on, and can damage, one or more components of the engine, such as the piston, piston rings, a connecting rod, the crankshaft, and the cylinder of the engine.

Another way of restricting the rotational speed of a crankshaft of the engine of a handheld power tool is to retard ignition timing when the rotational speed of the crankshaft reaches an upper threshold speed. Such a solution can reduce the emission levels from the engine as compared to a solution in which ignition events are skipped because there will be at least a late combustion of the air/fuel mixture in the cylinder of the engine which reduces the emission of unburnt fuel from the engine. However, such a solution for restricting the rotational speed is slower than a solution in which the ignition events are skipped. This is because also the late combustion events of the air/fuel mixture in the cylinder add a positive crankshaft torque to the crankshaft of the engine. Moreover, the late combustion events occurring as a result of the retardation of the ignition timing causes a significant increase of the exhaust temperature which can damage components of the engine.

Still another way of restricting the rotational speed of a crankshaft of an engine is to control a throttle valve of the engine to a closed position so as to restrict the airflow into the engine and thereby also the rotational speed of the crankshaft of the engine. Such a solution can reduce the fuel consumption and the emission levels from the engine as compared to the solutions described above. Moreover, such a solution of restricting the rotational speed of the crankshaft can improve the durability of the engine because the problems of high temperature exhaust gases and excessively large and intensive combustion events are avoided as compared to solutions of the types described above.

However, in solutions utilizing the closing of a throttle valve, the control of the throttle valve must made in a manner independent from input of the user to ensure durability of the engine. The position of the throttle valve must therefore be controlled by some type of automatic arrangement, such as an electric actuator arrangement, capable of moving the throttle valve to the closed position when the rotational speed of the crankshaft reaches an upper threshold speed.

Moreover, in such solutions, in order to be able to quickly restrict the rotational speed of the crankshaft, the electric actuator arrangement must be able to quickly move the throttle valve to the closed position. That is, in order to be able to quickly restrict the rotational speed of the crankshaft to ensure durability of the engine, the electric actuator arrangement must be able to move the throttle valve from an open position to a closed position within a couple of milliseconds. Moreover, due to the flowrate of air passing the throttle valve when the rotational speed of the crankshaft is in the region of the upper threshold speed, the valve faces a high resistance torque in the movement towards the closed position.

Thus, in solutions utilizing the closing of a throttle valve, the electric actuator arrangement must have a fast response and be strong enough to be able to quickly move the throttle valve to the closed position, which requires a large sized and heavy electric actuator arrangement. Such a large sized and heavy electric actuator arrangement is normally not suitable for use on a handheld power tool where mechanical simplicity and the weight of the handheld power tool are main concerns.

### SUMMARY

It is an object of the present invention to overcome, or at least alleviate, at least some of the above-mentioned problems and drawbacks.

According to a first aspect of the invention, the object is achieved by a method of restricting a rotational speed of a crankshaft of an internal combustion engine of a handheld power tool. The internal combustion engine comprises the crankshaft, a cylinder, a piston arranged in the cylinder and being connected to the crankshaft, an ignition device configured to ignite an air/fuel mixture in the cylinder, an air inlet system for conducting air to the cylinder, a throttle valve arranged in the air inlet system, and an electric actuator arrangement configured to move the throttle valve between an open position and a closed position. The throttle valve is configured to restrict flow of air through the air inlet system when positioned in the closed position. The method comprises the steps of, when the rotational speed of the crankshaft reaches above an upper threshold speed:
retarding an ignition timing of the ignition device from an initial ignition timing to a retarded ignition timing, and
controlling the electric actuator arrangement to move the throttle valve towards the closed position.

In this manner, the method provides conditions for obtaining a rapid restriction of the rotational speed of the crankshaft while allowing for the use of a small sized electric actuator arrangement for moving the throttle valve towards the closed position.

That is, since the method comprises the combination of the retarding of the ignition timing and the controlling of the electric actuator arrangement to move the throttle valve towards the closed position, a smaller, less costly, and more light-weighted electric actuator arrangement can be used for moving the throttle valve towards the closed position as compared to solutions in which the use of a closing of a throttle valve is the only means for restricting the rotational speed of the crankshaft. This is because it can be ensured that the rotational speed of the crankshaft is restricted during the time period needed for moving the throttle valve to the closed position thus allowing for a less rapid, strong, and heavy electric actuator arrangement.

Likewise, since the method comprises the combination of the retarding of the ignition timing and the controlling of the electric actuator arrangement to move the throttle valve towards the closed position, the time period needed for operation with the retarded ignition timing can be shortened as compared to solutions in which a retardation of the ignition timing is the only means for restricting the rotational speed of the crankshaft. Since the time period needed for operation with the retarded ignition timing can be shortened, long time periods of excessive exhaust temperatures can be avoided and thereby also damages to the engine.

Accordingly, a robust and reliable method is provided capable of quickly restricting the rotational speed of the crankshaft while avoiding damage of components of the engine.

Moreover, since the method comprises the step of controlling the electric actuator arrangement and the step of retarding the ignition timing, a method is provided capable of quickly restricting the rotational speed of the crankshaft without producing unnecessary emissions of unburnt fuel. As a further result thereof, a method is provided allowing the use of an exhaust aftertreatment arrangement, such as a catalytic converter, for treating exhaust gases from the engine.

Furthermore, since the method comprises the step of controlling the electric actuator arrangement to move the throttle valve towards the closed position, a method is provided capable of reducing the fuel consumption of the engine.

Accordingly, a method is provided overcoming, or at least alleviating, at least some of the above-mentioned problems and drawbacks. As a result, the above-mentioned object is achieved.

Optionally, the step of retarding the ignition timing of the ignition device comprises the step of:
maintaining a control of the ignition timing of ignition device to a retarded ignition timing when the rotational speed of the crankshaft is above the upper threshold speed.

Thereby, it can be ensured that the rotational speed of the crankshaft is restricted during at least a significant part of the time required for moving the throttle valve to the closed position. In other words, it can be ensured that the rotational speed of the crankshaft is quickly restricted while allowing for the use of a small sized electric actuator arrangement for moving the throttle valve.

Optionally, the step of retarding the ignition timing of the ignition device comprises the step of:
controlling the ignition timing of ignition device such that the ignition timing is retarded with increasing rotational speeds above the upper threshold speed.

Thereby, a situation-based control is obtained capable of restricting the rotational speed of the crankshaft in a quick and efficient manner in a wider range of operational conditions of the handheld power tool.

Optionally, the step of retarding the ignition timing of the ignition device comprises the step of:
controlling the ignition timing of ignition device such that the ignition timing is advanced with decreasing rotational speeds above the upper threshold speed.

Thereby, a situation-based control is obtained capable of restricting the rotational speed of the crankshaft in a quick and efficient manner in a wide range of operational conditions of the handheld power tool while avoiding the generation of hot exhaust gasses for long periods of time. Thus, in this manner, damages of components of the engine can be further avoided.

Optionally, the method comprises the step of:
advancing the ignition timing to the initial ignition timing when the rotational speed of the crankshaft declines below the upper threshold speed.

Thereby, a situation-based control is obtained capable of restricting the rotational speed of the crankshaft in a quick and efficient manner while avoiding the generation of hot exhaust gasses for long periods of time. Thus, in this manner, damages of components of the engine can be further avoided.

Optionally, the method comprises the step of:
controlling the electric actuator arrangement to move the throttle valve to the open position when the rotational speed of the crankshaft declines below the upper threshold speed.

Thereby, a situation-based control is obtained capable of restricting the rotational speed of the crankshaft in a quick and efficient manner while avoiding an excessive restriction of the rotational speed of the crankshaft.

According to a second aspect of the invention, the object is achieved by a control arrangement configured to restrict a rotational speed of a crankshaft of an internal combustion engine of a handheld power tool, wherein the internal combustion engine comprises the crankshaft, a cylinder, a piston arranged in the cylinder and being connected to the crankshaft, an ignition device configured to ignite an air/fuel mixture in the cylinder, an air inlet system for conducting air to the cylinder, a throttle valve arranged in the air inlet system, and an electric actuator arrangement configured to move the throttle valve between an open position and a closed position. The throttle valve is configured to restrict flow of air through the air inlet system when positioned in the closed position. The control arrangement is configured to, when the rotational speed of the crankshaft reaches above an upper threshold speed:
retard an ignition timing of the ignition device from an initial ignition timing to a retarded ignition timing, and
control the electric actuator arrangement to move the throttle valve towards the closed position.

In this manner, a control arrangement is provided having conditions for obtaining a rapid restriction of the rotational speed of the crankshaft while allowing for the use of a small sized electric actuator arrangement for moving the throttle valve towards the closed position.

That is, since the control arrangement is configured to retard the ignition timing and control the electric actuator arrangement to move the throttle valve towards the closed position, a smaller, less costly, and more light-weighted electric actuator arrangement, can be used for moving the throttle valve towards the closed position as compared to solutions in which the use of a closing of a throttle valve is the only means for restricting the rotational speed of the crankshaft. This is because it can be ensured that the rotational speed of the crankshaft is restricted during the time period needed for moving the throttle valve to the closed position thus allowing for the use of a less rapid, strong, and heavy electric actuator arrangement.

Likewise, since the control arrangement is configured to control the electric actuator arrangement to move the throttle valve towards the closed position, the time period needed for operation with the retarded ignition timing can be shortened as compared to solutions in which a retardation of the ignition timing is the only means for restricting the rotational speed of the crankshaft. Since the time period needed for operation with the retarded ignition timing can be shortened, long time periods of excessive exhaust temperatures can be avoided and thereby also damages to the engine.

Accordingly, a control arrangement is provided capable of quickly restricting the rotational speed of the crankshaft in a robust and reliable manner while avoiding damage of components of the engine.

Moreover, since the control arrangement is configured to retard the ignition timing and control the electric actuator arrangement to move the throttle valve towards the closed position, a control arrangement is provided capable of quickly restricting the rotational speed of the crankshaft without producing unnecessary emissions of unburnt fuel. As a further result thereof, a control arrangement is provided allowing the use of an exhaust aftertreatment arrangement, such as a catalytic converter, for treating exhaust gases from the engine.

Furthermore, since the control arrangement is configured to retard the ignition timing and control the electric actuator arrangement to move the throttle valve towards the closed position, a control arrangement is provided capable of reducing the fuel consumption of the engine.

Accordingly, a control arrangement is provided overcoming, or at least alleviating, at least some of the above-mentioned problems and drawbacks. As a result, the above-mentioned object is achieved.

It will be appreciated that the various embodiments described for the method are all combinable with the control arrangement as described herein. That is, the control arrangement according to the second aspect of the invention may be configured to perform any one of the method steps of the method according to the first aspect of the invention.

According to a third aspect of the invention, the object is achieved by a handheld power tool comprising an internal combustion engine for powering a tool of the handheld power tool, wherein the internal combustion engine comprises the crankshaft, a cylinder, a piston arranged in the cylinder and being connected to the crankshaft, an ignition device configured to ignite an air/fuel mixture in the cylinder, an air inlet system for conducting air to the cylinder, a throttle valve arranged in the air inlet system, and an electric actuator arrangement configured to move the throttle valve between an open position and a closed position. The throttle valve is configured to restrict flow of air through the air inlet system when positioned in the closed position. The handheld power tool comprises a control arrangement configured to, when the rotational speed of the crankshaft reaches above an upper threshold speed:
retard an ignition timing of the ignition device from an initial ignition timing to a retarded ignition timing, and
control the electric actuator arrangement to move the throttle valve towards the closed position.

In this manner, a handheld power tool is provided having conditions for a rapid restriction of the rotational speed of the crankshaft while allowing for the use of a small sized electric actuator arrangement for moving the throttle valve towards the closed position.

In other words, a handheld power tool is provided in which a smaller, less costly, and more light-weighted electric actuator arrangement can be used for moving the throttle valve towards the closed position as compared to solutions in which the use of a closing of a throttle valve is the only means for restricting the rotational speed of the crankshaft while ensuring a rapid restriction of the rotational speed of the crankshaft and avoiding long time periods of excessive exhaust temperatures.

Accordingly, a handheld power tool is provided capable of quickly restricting the rotational speed of the crankshaft in a robust and reliable manner while avoiding damage of components of the engine and avoiding unnecessary emissions of unburnt fuel.

Moreover, a handheld power tool is provided allowing the use of an exhaust aftertreatment arrangement, such as a catalytic converter, for treating exhaust gases from the engine of the handheld power tool.

Furthermore, since the control arrangement of the handheld power tool is configured to retard the ignition timing and control the electric actuator arrangement to move the throttle valve towards the closed position, a handheld power tool is provided having conditions for a reduced fuel consumption.

Accordingly, a handheld power tool is provided overcoming, or at least alleviating, at least some of the above-mentioned problems and drawbacks. As a result, the above-mentioned object is achieved.

Optionally, the electric actuator arrangement comprises an electric motor. Thereby, conditions are provided for a simple and cost-efficient electric actuator arrangement capable of moving the throttle valve towards the closed position when the rotational speed of the crankshaft reaches above the upper threshold speed.

Optionally, the electric motor is a stepper motor. Thereby, the need for a sensor is circumvented for monitoring a current position of the throttle valve.

Optionally, the electric actuator arrangement comprises a transmission, and wherein the electric motor comprises an output shaft connected to the throttle valve via the transmission. Thereby, conditions are provided for using a small and light-weighted electric motor while being able to produce a torque needed for moving the throttle valve to the closed position.

Optionally, the transmission provides a positive gear ratio between the output shaft of the electric motor and the throttle valve. Thereby, conditions are provided for using a small and light-weighted electric motor while being able to produce a torque needed for moving the throttle valve to the closed position.

Optionally, the transmission comprises a planetary gear set. Thereby, conditions are provided for a simple, efficient, and compact transmission having a relatively high gear ratio between the output shaft of the electric motor and the throttle valve. Moreover, conditions are provided for arranging the planetary gear set coaxially in relation to the output shaft of the electric motor, and/or coaxially in relation to a shaft of the throttle valve, to thereby obtain a compact electric actuator arrangement.

Optionally, the internal combustion engine comprises a crankcase at least partially enclosing the crankshaft, wherein the air inlet system comprises an air inlet duct connected to the crankcase, and wherein the throttle valve is arranged in the air inlet duct. Thereby, conditions are provided for an efficient restriction of airflow flowing into the engine when the throttle valve is controlled towards the closed position.

Optionally, the internal combustion engine is a crankcase scavenged two-stroke internal combustion engine, and wherein the air inlet system is configured to conduct air to the cylinder at least partially via a crankcase of the internal combustion engine. Thereby, conditions are provided for a handheld power tool comprising an engine being mechanically simple, light-weighted, and having a high power-to-weight ratio.

Optionally, the internal combustion engine comprises a main throttle valve arranged in the air inlet system, wherein the handheld power tool comprises a first handle and a throttle actuator arranged at the first handle, and wherein the throttle actuator is operably connected to the main throttle valve. Thereby, the throttle valve can be moved towards the closed position in a manner independent from the position and the control of the main throttle valve when the rotational speed of the crankshaft reaches above the upper threshold speed. In this manner, the rotational speed of the crankshaft can be restricted in a more reliable manner.

Furthermore, a handheld power tool is provided in which the power of the engine can be regulated in a simple, efficient, and reliable manner, wherein the control of the position of the main throttle valve is independent of the functionality and the operation of the electric actuator arrangement.

Optionally, the throttle actuator is operably connected to the main throttle valve via a mechanical connection. Thereby, a simple, efficient, and reliable connection is provided between the throttle actuator and the main throttle valve which provides conditions for a simple, efficient, and reliable control of the power of the engine.

Furthermore, a more light-weighted solution can be provided for controlling the power of the engine as compared to a solution in which the main throttle valve is controlled by an electric actuator assembly. Moreover, a more light-weighted solution can be provided for controlling the power of the engine as compared to a solution in which the engine comprises one throttle valve used for controlling the power of the engine and for restricting the rotational speed of the crankshaft of the engine according to the features of the control arrangement and the method of the embodiments herein.

That is, in order to be able to control the power of the engine according to the above-mentioned solutions, the electric actuator assembly needs to be relative quick and strong which requires a relatively large and heavy electric actuator assembly. Moreover, in such solutions, a position sensor is normally needed for sensing the position of the throttle actuator and probably also a battery to able to obtain a position reading of the throttle actuator before and during start-up of the engine. Such components add weight and complexity to a handheld power tool.

Accordingly, since the internal combustion engine comprises the main throttle valve, and since the throttle actuator is operably connected to the main throttle valve via the mechanical connection, a low weight and non-complex solution can be provided for controlling the power of the engine.

Optionally, the internal combustion engine comprises an exhaust system configured to conduct exhaust gas from the cylinder to the surroundings, and wherein the exhaust system comprises a catalytic converter. Thereby, a more environmentally friendly handheld power tool is provided capable of generating lower emissions of unburnt hydrocarbons. Moreover, since the control arrangement is configured to restrict the rotational speed of the crankshaft by retarding the ignition timing and controlling the electric actuator arrangement to move the throttle valve towards the closed position, the functionality and durability of the catalytic converter can be ensured.

Optionally, the handheld power tool is a chainsaw or a power cutter. Thereby, a chainsaw or a power cutter is provided having at least some of the above mentioned advantages.

Further features of, and advantages with, the present invention will become apparent when studying the appended claims and the following detailed description.

### BRIEF DESCRIPTION OF THE DRAWINGS

Various aspects of the invention, including its particular features and advantages, will be readily understood from the example embodiments discussed in the following detailed description and the accompanying drawings, in which:

FIG. 1 illustrates a first side view of a handheld power tool according to some embodiments of the present disclosure,

FIG. 2 schematically illustrates a cross section of an internal combustion engine of the handheld power tool illustrated in FIG. 1,

FIG. 3 schematically illustrates the cross section of the internal combustion engine illustrated in FIG. 2 in which a throttle valve has been moved from an open position to a closed position by an electric actuator arrangement, and

FIG. 4 schematically illustrates a method of restricting a rotational speed of a crankshaft of an internal combustion engine of a handheld power tool.

### DETAILED DESCRIPTION

Aspects of the present invention will now be described more fully. Like numbers refer to like elements throughout. Well-known functions or constructions will not necessarily be described in detail for brevity and/or clarity.

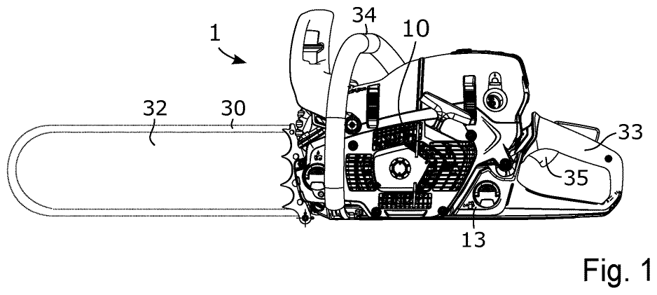

FIG. 1 illustrates a first side view of a handheld power tool 1 according to some embodiments of the present disclosure. The handheld power tool 1 comprises a tool 30 and an internal combustion engine 10 configured to power the tool 30. According to the illustrated embodiments, the handheld power tool 1 is a chainsaw comprising a tool 30 in the form of a cutting chain movably arranged around a guide bar 32. In FIG. 1, the cutting chain and the guide bar 32 are schematically illustrated.

The internal combustion engine 10 is configured to rotate the cutting chain around the guide bar 32 during operation of the handheld power tool 1. According to further embodiments, the handheld power tool 1, as referred to herein, may be another type of handheld power tool 1 than a chainsaw, such as for example a power cutter, a circular saw, a trimmer, a hedge trimmer, a multi-tool, or the like. Obviously, according to such embodiments, the handheld power tool 1 may comprise another type of tool 30 than a cutting chain, such as for example a circular saw blade, a trimmer head, a hedge trimmer cutting assembly, or the like. The handheld power tool 1 comprises a fuel tank 13 configured to store fuel which is supplied to the internal combustion engine 10 during operation thereof. The internal combustion engine 10 of the handheld power tool 20 may be configured to run on gasoline, also referred to as petrol, alcohol, similar volatile fuels, or combinations thereof.

The handheld power tool 1 comprises a first handle 33 and a second handle 34. The second handle 34 is separate from the first handle 33 and is arranged at a distance from the first handle 33. The handheld power tool 1 is configured to be supported via each of the first and second handles 33, 34 during operation of the handheld power tool 1. In other words, the handheld power tool 1 is configured to be supported by two hands of a user during operation of the handheld power tool 1, i.e., is configured to be supported by one hand grabbing the first handle 33 and the other hand grabbing the second handle 34.

According to the illustrated embodiments, the first handle 33 is a rear handle arranged at a rear portion of the handheld power tool 1 and the second handle 34 is a so-called front handle. According to the illustrated embodiments, the second handle 34 is arranged closer to the tool 30 of the handheld power tool 1 than the first handle 33. Moreover, the second handle 34 is arranged at a position between the tool 30 of the handheld power tool 1 and the first handle 33 of the handheld power tool 1. According to the illustrated embodiments, the second handle 34 is formed by an elongated curved-shaped body allowing a user to grip the second handle 34 from various directions in a convenient manner. Thereby, a user is allowed to operate the handheld power tool 1 at different orientations relative to the gravitational field in a convenient and safe manner.

The handheld power tool 1 comprises a throttle actuator 35 arranged at the first handle 33. The throttle actuator 35 can be used to control a power output of the internal combustion engine 10 as is further explained herein.

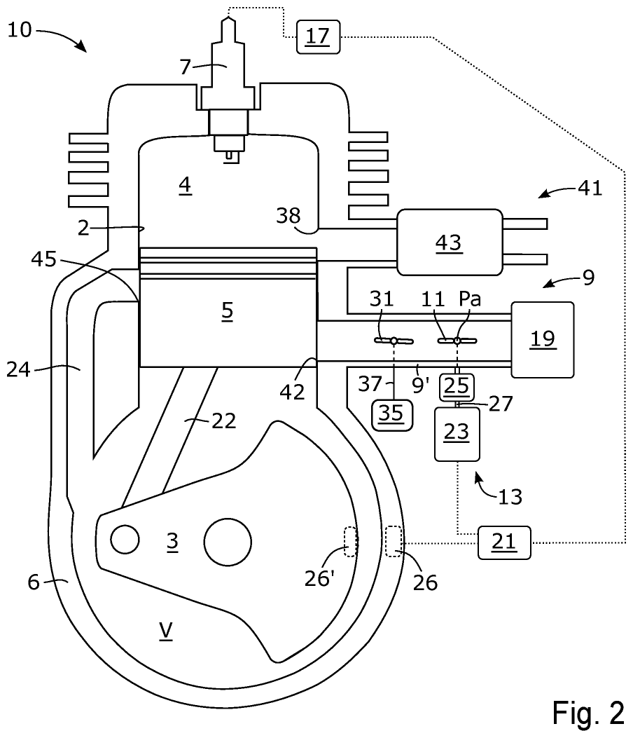

FIG. 2 schematically illustrates a cross section of the internal combustion engine 10 of the handheld power tool 1 illustrated in FIG. 1. The internal combustion engine 10 is also referred to as the “combustion engine” or simply the “engine” for reasons of brevity and clarity. Below, simultaneous reference is made to FIG. 1 and FIG. 2, if not indicated otherwise.

The combustion engine 10 comprises a crankshaft 3, a cylinder 2, and a piston 5 arranged in the cylinder 2. The combustion engine 10 comprises a connecting rod 22 connecting the piston 5 to the crankshaft 3 such that the piston 5 reciprocates within the cylinder 2 between a bottom dead centre and a top dead centre upon rotation of the crankshaft 3. In other words, the piston 5 is connected to the crankshaft 3 via the connection rod 22. In FIG. 2, the piston 5 is illustrated as positioned between the top dead centre and the bottom dead centre. According to the illustrated embodiments, the internal combustion engine 10 of the handheld power tool 1 is a small sized crankcase scavenged two-stroke internal combustion engine.

According to further embodiments, the internal combustion engine 10, as referred to herein, may be a four-stroke internal combustion engine, such as a small sized four-stroke internal combustion engine. The term “small sized” in this context may encompass that the engine 10 has an engine displacement of less than 250 cubic centimetres.

The internal combustion engine 10 comprises a crankcase 6 enclosing a crankcase volume V. The crankcase 6 encloses part of the crankshaft 3. In other words, at least part of the crankshaft 3 is arranged inside the crankcase volume V of the crankcase 6.

The piston 5 comprises a first face forming a delimiting surface of a combustion chamber 4 and a second face forming a delimiting surface of the crankcase volume V. The first face of the piston 5 thus faces the combustion chamber 4 and the second face of the piston 5 faces the crankcase 6 of the engine 10. The size of the crankcase volume V decreases upon movement of the piston 5 in a direction towards the bottom dead centre. In this manner, the pressure inside the crankcase volume V of the crankcase 6 can be increased upon movement of the piston 5 towards the bottom dead centre, as is further explained herein.

Moreover, the size of the crankcase volume V is at a minimum when the piston 5 is at the bottom dead centre and the size of the crankcase volume V is at a maximum when the piston 5 is at the top dead centre because the second face of the piston 5 forms a delimiting surface of the crankcase volume V of the crankcase 6. Thus, the piston 5 of the engine 10 according to embodiments herein acts like a scavenging pump member, i.e., a pump member for replacing combustion gas inside the combustion chamber 4 of the engine 10, as is further explained herein.

The engine 10 comprises the air inlet system 9 configured to conduct air to the cylinder 2 during operation of the engine 10. According to the illustrated embodiments, the air inlet system 9 comprises an air inlet duct 9′connected to the crankcase 6. Moreover, the air inlet system 9 comprises an air filter unit 19 connected to the air inlet duct 9′. Thus, according to the illustrated embodiments, the air inlet system 9 is configured to conduct air to the cylinder 2 via the crankcase 6 of the internal combustion engine 10. The cylinder 2 of the engine 10 comprises air inlet port 42. The air inlet port 42 fluidly connects the crankcase 6 to the air inlet duct 9′ when the piston is in a region of the top dead centre.

The engine 10 comprises a main throttle valve 31 arranged in the air inlet duct 9′ of the air inlet system 9. The throttle actuator 35 of the handheld power tool 1 illustrated in FIG. 1 is operably connected to the main throttle valve 31. In more detail, according to these embodiments, the throttle actuator 35 is operably connected to the main throttle valve 31 via a mechanical connection 37 schematically indicated in FIG. 2. In this manner, the amount of air sucked into the cylinder 2 of the engine 10, and thereby also the power produced by the engine 10, can be regulated in a simple and reliable manner via the throttle actuator 35, as is further explained herein.

According to the illustrated embodiments, the air inlet port 42 is provided in a wall of the cylinder 2 and a pressure increase is obtained in the crankcase volume V of the crankcase 6 upon movement of the piston 5 in the direction towards the bottom dead centre due to the closing of the air inlet port 42 by a mantle surface of the piston 5. However, according to further embodiments, the air inlet duct 9′ may be connected directly to the crankcase 6 and the engine 10 may lack an air inlet port 42 provided in a wall of the cylinder 2. According to such embodiments, as well as in other embodiments herein, the engine 10 may comprise one or more one-way valves, such as reed valves, arranged to hinder a flow of gas from the crankcase volume V of the crankcase 6 to the air inlet duct 9′ upon movement of the piston 5 towards the bottom dead centre.

As seen in FIG. 2, the engine 10 comprises an inlet port 45 provided in a wall of the cylinder 2. Moreover, the engine 10 comprises a scavenging channel 24 which fluidly connects the crankcase volume V of the crankcase 6 and the inlet port 45. According to the illustrated embodiments, the inlet port 45 is open when the piston 5 is in a region of the bottom dead centre. In more detail, according to the illustrated embodiments, the inlet port 45 is closed by the mantle surface of the piston 5 when the mantle surface of the piston 5 is above an upper edge of the inlet port 45, wherein the inlet port 45 is opened, i.e., uncovered, when the mantle surface of the piston 5 is moved in the direction towards the bottom dead centre and reaches a position in which the mantle surface of the piston 5 is below the upper edge of the inlet port 45. The term “upper edge” as used herein means an edge of the inlet port 45 being the uppermost edge if the engine is oriented relative to a local gravity field such that the direction from the top dead centre towards the bottom dead centre coincides with a local gravity vector. Obviously, the engine 10 may be configured to operate at other orientations relative to a local gravity field.

As understood from the above, when the inlet port 45 is opened, a transport of gas, such as air or an air/fuel mixture, is obtained from the crankcase volume V of the crankcase 6 into the combustion chamber 4 via the scavenging channel 24 and the inlet port 45 indicated in FIG. 2. The engine 10 may comprise more than one inlet port 45 and more than one scavenging channel 24.

The engine 10 comprises an exhaust system 41 configured to conduct exhaust gas from the cylinder 2 to the surroundings. According to the illustrated embodiments, the exhaust system 41 comprises a catalytic converter 43. Furthermore, as is seen in FIG. 2, the engine 10 comprises an exhaust port 38 provided in a wall of the cylinder 2. The exhaust port 38 is fluidly connected to the exhaust system 41 of the engine 10. The inlet port 45 and the exhaust port 38 are configured such that an upper edge of the exhaust port 38 is above the upper edge of the inlet port 45.

The feature that the upper edge of the exhaust port 38 is above the upper edge of the inlet port 45 means that an uppermost edge of the exhaust port 38 is located above the uppermost edge of the inlet port 45 as seen relative to a local gravity vector when the engine 10 is oriented relative to a local gravity field such that the direction from the top dead centre towards the bottom dead centre coincides with the local gravity vector.

Accordingly, due to these features, the inlet port 45 becomes fully closed prior to the exhaust port 38 upon movement of the piston 5 from the bottom dead centre towards the top dead centre. When each of the inlet port 45 and the exhaust port 38 is fully closed, the gas trapped inside the combustion chamber 4 is compressed by the movement of the piston 5 towards the top dead centre.

The engine 10 further comprises a fuel supply system. The fuel supply system is not indicated in FIG. 2 for reasons of brevity and clarity. The fuel supply system may comprise one or more of a carburettor arranged in the air inlet system 9 of the engine 10, such as in the air inlet duct 9′ of the air inlet system 9. As an alternative, or in addition, the engine 10 may comprise one or more of a fuel injector configured to inject fuel into the crankcase volume V of the crankcase 6, a fuel injector configured to inject fuel into the combustion chamber 4, and a fuel injector configured to inject fuel into a scavenging channel 24, or the like.

Thus, fuel added to, or transported to, the combustion chamber 4 from such a fuel supply system may, together with air trapped in the combustion chamber 4, be compressed when each of the inlet port 45 and the exhaust port 38 is fully closed and the piston 5 moves in the direction towards the top dead centre.

The engine 10 further comprises an ignition device 7. The ignition device 7 is configured to ignite an air/fuel mixture in the cylinder 2. According to the illustrated embodiments, the ignition device 7 is a spark plug, i.e., an ignition device configured to ignite the air/fuel mixture by generating a spark inside the combustion chamber 4 when being supplied with a high electrical voltage. According to further embodiments, the engine 10 may comprise another type of ignition device than a spark plug.

According to the illustrated embodiments, the engine 10 comprises an ignition system 17 configured to control the ignition device 7 to ignite the air/fuel mixture in the combustion chamber 4 based on the rotational position of the crankshaft 3 of the engine 10. According to the illustrated embodiments, the engine 10 comprises a sensor arrangement 26, 26′ configured to sense a current rotational position of the crankshaft 3, wherein the ignition system 17 is operably connected to sensor arrangement 26, 26′ and is configured to configured to control the ignition device 7 to ignite the air/fuel mixture in the combustion chamber 4 based on the sensed current rotational position of the crankshaft 3.

During normal operation of the engine 10, the ignition device 7 is controlled to ignite the air/fuel mixture in the combustion chamber 4 when the piston 5 is a number of crank angle degrees from the top dead centre in its movement towards the top dead centre. During the remaining movement of the piston 5 towards the top dead centre, the combustion of the air/fuel mixture develops and the increased pressure and temperature in the combustion chamber 4 resulting from the combustion therein forces the piston 5 in the direction towards the bottom dead centre. This force on the piston 5 can be converted into mechanical work supplied to the crankshaft 3 of the engine 10.

Due to the arrangement of the exhaust port 38 and the inlet port 45, the exhaust port 38 is opened earlier than the inlet port 45 upon movement of the piston 5 in the direction d2 towards the bottom dead centre. In this manner, exhaust gas can be expelled from the combustion chamber 4 to the exhaust system 42 before fresh air is transported into the combustion chamber 4 via the scavenging channel 24 and the inlet port 45 by the pumping action obtained from the movement of the piston 5 towards the bottom dead centre.

According to embodiments herein, the engine 10 comprises a throttle valve 11 arranged in the air inlet system 9. The throttle valve 11 is separate from the main throttle valve 31 and may also be referred to as a supplementary or additional throttle valve 11. According to the illustrated embodiments the throttle valve 11 is arranged in the air inlet duct 9′ of the air inlet system 9. Moreover, the engine 10 comprises an electric actuator arrangement 13 configured to move the throttle valve 11 between an open position and a closed position.

In FIG. 2, the throttle valve 11 is illustrated in the open position. The open position of the throttle valve 11 constitutes a position in which the throttle valve 11 provides no, or only a minor, restriction on air flowing through the air inlet system 9. The closed position of the throttle valve 11 constitutes a position in which the throttle valve 11 restricts flow of air through the air inlet system 9. The wording restricts flow of air, as used herein, means a partial blockage of air flowing through the air inlet system 9.

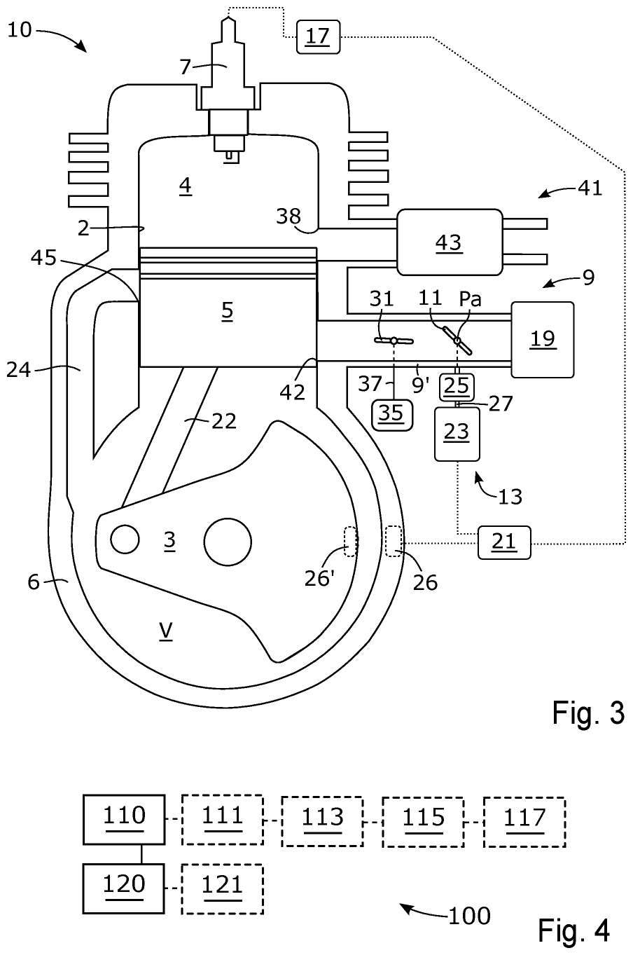

FIG. 3 schematically illustrates the cross section of the internal combustion engine 10 illustrated in FIG. 2 in which the throttle valve 11 has been moved from the open position illustrated in FIG. 2 to the closed position by the electric actuator arrangement 13. Below, simultaneous reference is made to FIG. 1-FIG. 3, if not indicated otherwise.

As seen in FIG. 2 and FIG. 3, according to the illustrated embodiments, the throttle valve 11 is a type of butterfly valve. According to further embodiments, the throttle valve 11 may comprise another type of valve. According to the illustrated embodiments, the throttle valve 11 is pivotally arranged around a pivot axis Pa. As seen in FIG. 2, according to these embodiments, the open position of the throttle valve 11 constitutes a position in which the throttle valve 11 is positioned such that the throttle valve 11 is substantially parallel to an air flow direction through the air inlet duct 9′ of the air inlet system 9. In this manner, the throttle valve 11 provides no, or only a minor, restriction on air flowing through the air inlet system 9 when the throttle valve 11 is positioned in the open position. Therefore, according to the illustrated embodiments, the “open position” of the throttle valve 11, as referred to herein, may also be referred to as a “fully open position”.

Moreover, as seen in FIG. 3, according to these embodiments, the closed position of the throttle valve 11 constitutes a position in which the throttle valve 11 is positioned such that the throttle valve 11 is transversal to the air flow direction through the air inlet duct 9′ of the air inlet system 9. In this manner, the throttle valve 11 provides a restriction on, i.e., a partial blockage of, the flow of air through the air inlet duct 9′ of the air inlet system 9 when positioned in the closed position. As seen in FIG. 3, the throttle valve 11 does not fully block flow of air through the air inlet duct 9′ of the air inlet system 9 when positioned in the closed position. Therefore, according to the illustrated embodiments, the “closed position” of the throttle valve 11, as referred to herein, may also be referred to as an “at least partially closed position”.

According to the illustrated embodiments, the electric actuator arrangement 13 comprises an electric motor 23. The electric motor 23 may be a stepper motor. In this manner, the need for a sensor is circumvented for monitoring the position of the throttle valve. Moreover, according to the illustrated embodiments, the electric actuator arrangement 13 comprises a transmission 25, and the electric motor 23 comprises an output shaft 27 connected to the throttle valve 11 via the transmission 25. According to the illustrated embodiments, the transmission 25 provides a positive gear ratio between the output shaft 27 of the electric motor 23 and the throttle valve 11. In this manner, a small sized electric motor 23 can be used for moving the throttle valve 11 while being able to generate the torque needed for moving the throttle valve 11 at various operational conditions of the engine 10.

In more detail, according to the illustrated embodiments, the transmission 25 comprises a planetary gear set. The planetary gear set is arranged coaxially in relation to the output shaft 27 of the electric motor 23 as well as coaxially in relation to a shaft of the throttle valve 11. In this manner, a compact electric actuator arrangement 13 can be obtained. Moreover, by utilizing a planetary gear set between the output shaft 27 of the electric motor 23 and the throttle valve 11, conditions are provided for a simple, efficient, and compact transmission having a high gear ratio between the output shaft 27 of the electric motor 23 and the throttle valve 11.

The engine 10 comprises a control arrangement 21 operably connected to the electric actuator arrangement 13 and to the ignition device 7 of the engine 10. According to the illustrated embodiments, the control arrangement 21 is operably connected to the ignition device 7 by being operably connected to the ignition system 17.

In FIG. 2, each of the throttle valve 11 and the main throttle valve 31 is illustrated in a respective open position. The engine 10 illustrated in FIG. 2 is thus illustrated as operated in a full throttle situation, i.e., in a full power situation.

According to embodiments herein, the control arrangement 21 is configured to, when the rotational speed of the crankshaft 3 reaches above an upper threshold speed, retard an ignition timing of the ignition device 7 from an initial ignition timing to a retarded ignition timing and is configured to control the electric actuator arrangement 13 to move the throttle valve 11 towards the closed position.

The closing of the throttle valve 11, i.e., the movement of the throttle valve 11 from the open position to the closed position, is associated with a certain closing time. The closing time of the throttle valve 11, i.e., the time needed for moving the throttle valve 11 from the open position to the closed position may for example be a few tenths of a seconds. Purely as examples, the closing time of the throttle valve 11 may be within the range of 0.04-0.35 seconds, or 0.07-0.2 seconds.

However, since the control arrangement 21 is configured to retard the ignition timing of the ignition device 7 from the initial ignition timing to the retarded ignition timing and is configured to control the electric actuator arrangement 13 to move the throttle valve 11 towards the closed position when the rotational speed of the crankshaft 3 reaches above the upper threshold speed, a rapid restriction of the rotational speed of the crankshaft 3 can be provided while allowing for the use of a small sized electric actuator arrangement 13 for moving the throttle valve 11 towards the closed position.

The exhaust temperature, i.e., the temperature of exhaust gasses flowing from the combustion chamber 4 into the exhaust system 41 via the exhaust port 38, is increased when retarding the ignition timing. This can partly be explained by the fact that that a lower proportion of the energy of the combustion of the air/fuel mixture in the combustion chamber 4 is converted into mechanical work supplied to the crankshaft 3 of the engine 10 upon late combustion in the combustion chamber 4.

However, since the control arrangement 21 is configured to control the electric actuator arrangement 13 to move the throttle valve 11 towards the closed position when the rotational speed of the crankshaft 3 reaches above the upper threshold speed, the time period needed for operation with the retarded ignition timing can be shortened as compared to solutions in which a retardation of the ignition timing is the only means for restricting the rotational speed of the crankshaft of an engine. Since the time period needed for operation with the retarded ignition timing can be shortened, long time periods of excessive exhaust temperatures can be avoided. In this manner, damages to the engine 10 can be avoided.

The control arrangement 21 may be configured to control the electric actuator arrangement 13 to move the throttle valve 11 between the open and closed positions using the current rotational speed of the crankshaft 3 as an input. According to some embodiments, the control arrangement 21 may be configured to control the electric actuator arrangement 13 to move the throttle valve 11 towards the closed position when the rotational speed of the crankshaft 3 reaches above the upper threshold speed and may be configured to control the electric actuator arrangement 13 to move the throttle valve 11 towards the open position when the rotational speed of the crankshaft 3 declines below the upper threshold speed.

According to some embodiments, the control arrangement 21 may comprise a proportional-integral-derivative controller, also referred to as a PID controller or three-term controller, using the current rotational speed of the crankshaft 3, a wanted rotational speed of the crankshaft 3, a current position of the throttle valve 11, and a wanted position of the throttle valve 11 as input.

Purely, as examples, the upper threshold speed as referred to herein, may be within the range of 7 000-15 000 revolutions per minute, or may be within the range of 12 000-14 000 revolutions per minute.

The control arrangement 21 may be configured to retard the ignition timing of ignition device 7 such that the ignition timing is retarded with increasing rotational speeds above the upper threshold speed. That is, the control arrangement 21 may be configured to control the ignition timing of ignition device 7 such that the size of the retardation at least substantially follows the extent by which the current rotational speed of the crankshaft 3 exceeds the upper threshold speed. Such a control may be performed such that the size of the retardation at least substantially linearly follows the extent by which the current rotational speed of the crankshaft 3 exceeds the upper threshold speed. The control arrangement 21 may be configured to control the ignition timing of ignition device 7 using map data and the current rotational speed of the crankshaft 3 as input.

The initial ignition timing, as referred to herein, is a current ignition timing being used when the rotational speed of the crankshaft 3 reaches the upper threshold speed. Purely, as an example, the initial ignition timing may be within the range of 6-15 crank angle degrees before the top dead centre of the piston 5. Such an initial ignition timing means that the ignition device 7 is controlled to ignite the air/fuel mixture in the combustion chamber 4 of the cylinder 2 when the piston is located 6-15 crank angle degrees before the top dead centre in its movement towards the top dead centre.

The retarded ignition timing, as referred to herein, is an ignition timing being retarded, i.e., delayed, relative to the initial ignition timing. As mentioned, the control of the ignition timing may be performed such that the size of the retardation at least substantially linearly follows the extent by which the current rotational speed of the crankshaft 3 exceeds the upper threshold speed. The control of the ignition timing may be performed such that the size of the retardation of the ignition timing is increased with increased rotational speeds above the upper threshold speed up to a maximum retardation of the ignition timing. Purely as an example, the maximum retardation of the ignition timing may be within the range of 15-35 crank angle degrees, or may be within the range of 20-30 crank angle degrees, from the initial ignition timing.

As understood from the above, in some operational conditions of the engine 10, the ignition timing of the ignition device 7 may be retarded to an ignition timing in which the air/fuel mixture in the combustion chamber 4 of the cylinder 2 is ignited a number of crank angle degrees after the top dead centre.

As implied above, the control arrangement 21 may be configured to control the ignition timing of ignition device 7 such that the ignition timing is advanced with decreasing rotational speeds above the upper threshold speed. The advancing of the ignition timing with decreasing rotational speeds above the upper threshold speed may correspond to the size of the retardation of the ignition timing given a certain difference in rotational speeds of the crankshaft 3 above the upper threshold speed. Moreover, as understood from the above, the control arrangement 21 may be configured to advance the ignition timing to the initial ignition timing when the rotational speed of the crankshaft 3 declines below the upper threshold speed.

FIG. 4 schematically illustrates a method 100 of restricting a rotational speed of a crankshaft of an internal combustion engine of a handheld power tool. The internal combustion engine may be an internal combustion engine 10 according to the embodiments illustrated in FIG. 2 and FIG. 3 and the handheld power tool may be a handheld power tool 1 according to the embodiments illustrated in FIG. 1. Therefore, below, simultaneous reference is made to FIG. 1-FIG. 4, if not indicated otherwise.

The method 100 is a method of restricting a rotational speed of a crankshaft 3 of an internal combustion engine 10 of a handheld power tool 1. The internal combustion engine 10 comprises a crankshaft 3, a cylinder 2, a piston 5 arranged in the cylinder 2 and being connected to the crankshaft 3, an ignition device 7 configured to ignite an air/fuel mixture in the cylinder 2, an air inlet system 9 for conducting air to the cylinder 2, a throttle valve 11 arranged in the air inlet system 9, and an electric actuator arrangement 13 configured to move the throttle valve 11 between an open position and a closed position. The throttle valve 11 is configured to restrict flow of air through the air inlet system 9 when positioned in the closed position. The method 100 comprises the steps of, when the rotational speed of the crankshaft 3 reaches above an upper threshold speed:
retarding 110 an ignition timing of the ignition device 7 from an initial ignition timing to a retarded ignition timing, and
controlling 120 the electric actuator arrangement 13 to move the throttle valve 11 towards the closed position.

The step of retarding 110 the ignition timing of the ignition device 7 the step of controlling 120 the electric actuator arrangement 13 to move the throttle valve 11 towards the closed position may be performed simultaneously when the rotational speed of the crankshaft 3 reaches above the upper threshold speed.

As indicated in FIG. 4, the step of retarding 110 the ignition timing of the ignition device 7 may comprise the step of:
maintaining 111 a control of the ignition timing of ignition device 7 to a retarded ignition timing when the rotational speed of the crankshaft 3 is above the upper threshold speed.

Moreover, as indicated in FIG. 4, the step of retarding 110 the ignition timing of the ignition device 7 may comprise the step of:
controlling 113 the ignition timing of ignition device 7 such that the ignition timing is retarded with increasing rotational speeds above the upper threshold speed.

Furthermore, as indicated in FIG. 4, the step of retarding 110 the ignition timing of the ignition device 7 may comprise the step of:
controlling 115 the ignition timing of ignition device 7 such that the ignition timing is advanced with decreasing rotational speeds above the upper threshold speed.

Moreover, as indicated in FIG. 4, the method 100 may comprise the step of:
advancing 117 the ignition timing to the initial ignition timing when the rotational speed of the crankshaft 3 declines below the upper threshold speed.

Furthermore, as indicated in FIG. 4, the method 100 may comprise the step of:
controlling 121 the electric actuator arrangement 13 to move the throttle valve 11 to the open position when the rotational speed of the crankshaft 3 declines below the upper threshold speed.

It will be appreciated that the various embodiments described for the method 100 are all combinable with the control arrangement 21 as described herein. That is, the control arrangement 21 may be configured to perform any one of the method steps 110, 111, 113, 115, 117, 120, and 121 of the method 100.

One skilled in the art will appreciate that the method 100 of restricting a rotational speed of a crankshaft 3 of an internal combustion engine 10 of a handheld power tool 1 may be implemented by programmed instructions. These programmed instructions are typically constituted by a computer program, which, when it is executed in the control arrangement 21, ensures that the control arrangement 21 carries out the desired control, such as the method steps 110, 111, 113, 115, 117, 120, and 121 described herein. The computer program is usually part of a computer program product which comprises a suitable digital storage medium on which the computer program is stored. According to such embodiments, the computer-readable medium comprises a computer program comprising instructions which, when the program is executed by a computer, cause the computer to carry out the method 100 according to some embodiments.

The control arrangement 21 may comprise a calculation unit which may take the form of substantially any suitable type of processor circuit or microcomputer, e.g., a circuit for digital signal processing (digital signal processor, DSP), a Central Processing Unit (CPU), a processing unit, a processing circuit, a processor, an Application Specific Integrated Circuit (ASIC), a microprocessor, or other processing logic that may interpret and execute instructions. The herein utilised expression “calculation unit” may represent a processing circuitry comprising a plurality of processing circuits, such as, e.g., any, some or all of the ones mentioned above.

The control arrangement 21 may further comprise a memory unit, wherein the calculation unit may be connected to the memory unit, which may provide the calculation unit with, for example, stored program code and/or stored data which the calculation unit may need to enable it to do calculations. The calculation unit may also be adapted to store partial or final results of calculations in the memory unit. The memory unit may comprise a physical device utilised to store data or programs, i.e., sequences of instructions, on a temporary or permanent basis. According to some embodiments, the memory unit may comprise integrated circuits comprising silicon-based transistors.

The control arrangement 21 is connected to components of the internal combustion engine 10 and/or components of the handheld power tool 1 for receiving and/or sending input and output signals. These input and output signals may comprise waveforms, pulses, or other attributes which the input signal receiving devices can detect as information and which can be converted to signals processable by the control arrangement 21. These signals may then be supplied to the calculation unit. One or more output signal sending devices may be arranged to convert calculation results from the calculation unit to output signals for conveying to other parts of the control system of the handheld power tool 1 and/or the component or components for which the signals are intended. Each of the connections to the respective components of the internal combustion engine 10 for receiving and sending input and output signals may take the form of one or more from among a cable or a wireless connection.

In the embodiments illustrated, the handheld power tool 1 comprises a control arrangement 21 but might alternatively be implemented wholly or partly in two or more control arrangements or two or more control units.

The computer program product may be provided for instance in the form of a data carrier carrying computer program code for performing at least some of the method steps 110, 111, 113, 115, 117, 120, and 121 according to some embodiments when being loaded into one or more calculation units of the control arrangement 21. The data carrier may be, e.g. a CD ROM disc, or a ROM (read-only memory), a PROM (programable read-only memory), an EPROM (erasable PROM), a flash memory, an EEPROM (electrically erasable PROM), a hard disc, a memory stick, an optical storage device, a magnetic storage device or any other appropriate medium such as a disk or tape that may hold machine readable data in a non-transitory manner. The computer program product may furthermore be provided as computer program code on a server and may be downloaded to the control arrangement 21.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

1. A method of restricting a rotational speed of a crankshaft of an internal combustion engine of a handheld power tool,
the internal combustion engine comprising:
the crankshaft,
a cylinder,
a piston arranged in the cylinder and being connected to the crankshaft,
an ignition device configured to ignite an air/fuel mixture in the cylinder,
an air inlet system for conducting air to the cylinder,
a throttle valve arranged in the air inlet system, and
an electric actuator arrangement configured to move the throttle valve between an open position and a closed position,
wherein the throttle valve is configured to restrict flow of air through the air inlet system when positioned in the closed position,
and wherein the method comprises the steps of, when the rotational speed of the crankshaft reaches above an upper threshold speed:
retarding an ignition timing of the ignition device from an initial ignition timing to a retarded ignition timing, and
controlling the electric actuator arrangement to move the throttle valve towards the closed position.

2. The method according to claim 1, wherein the step of retarding the ignition timing of the ignition device comprises the step of:
maintaining a control of the ignition timing of ignition device to a retarded ignition timing when the rotational speed of the crankshaft is above the upper threshold speed.

3. The method according to claim 1, wherein the step of retarding the ignition timing of the ignition device comprises the step of:
controlling the ignition timing of ignition device such that the ignition timing is retarded with increasing rotational speeds above the upper threshold speed.

4. The method according to claim 1, wherein the step of retarding the ignition timing of the ignition device comprises the step of:
controlling the ignition timing of ignition device such that the ignition timing is advanced with decreasing rotational speeds above the upper threshold speed.

5. The method according to claim 1, wherein the method comprises the step of:
advancing the ignition timing to the initial ignition timing when the rotational speed of the crankshaft declines below the upper threshold speed.

6. The method according to claim 1, wherein the method comprises the step of:
controlling the electric actuator arrangement to move the throttle valve to the open position when the rotational speed of the crankshaft declines below the upper threshold speed.

7. A control arrangement configured to restrict a rotational speed of a crankshaft of an internal combustion engine of a handheld power tool, wherein the internal combustion engine comprises:
the crankshaft,
a cylinder,
a piston arranged in the cylinder and being connected to the crankshaft,
an ignition device configured to ignite an air/fuel mixture in the cylinder,
an air inlet system for conducting air to the cylinder,
a throttle valve arranged in the air inlet system, and
an electric actuator arrangement configured to move the throttle valve between an open position and a closed position,
wherein the throttle valve is configured to restrict flow of air through the air inlet system when positioned in the closed position,
and wherein the control arrangement is configured to, when the rotational speed of the crankshaft reaches above an upper threshold speed:
retard an ignition timing of the ignition device from an initial ignition timing to a retarded ignition timing, and
control the electric actuator arrangement to move the throttle valve towards the closed position.

8. A handheld power tool comprising an internal combustion engine for powering a tool of the handheld power tool,
wherein the internal combustion engine comprises:
the crankshaft,
a cylinder,
a piston arranged in the cylinder and being connected to the crankshaft,
an ignition device configured to ignite an air/fuel mixture in the cylinder,
an air inlet system for conducting air to the cylinder,
a throttle valve arranged in the air inlet system, and
an electric actuator arrangement configured to move the throttle valve between an open position and a closed position,
wherein the throttle valve is configured to restrict flow of air through the air inlet system when positioned in the closed position,
and wherein the handheld power tool comprises a control arrangement configured to, when the rotational speed of the crankshaft reaches above an upper threshold speed:
retard an ignition timing of the ignition device from an initial ignition timing to a retarded ignition timing, and
control the electric actuator arrangement to move the throttle valve towards the closed position.

9. The handheld power tool according to claim 8, wherein the electric actuator arrangement comprises an electric motor.

10. The handheld power tool according to claim 9, wherein the electric motor is a stepper motor.

11. The handheld power tool according to claim 9, wherein the electric actuator arrangement comprises a transmission, and wherein the electric motor comprises an output shaft connected to the throttle valve via the transmission.

12. The handheld power tool according to claim 11, wherein the transmission provides a positive gear ratio between the output shaft of the electric motor and the throttle valve.

13. The handheld power tool according to claim 11, wherein the transmission comprises a planetary gear set.

14. The handheld power tool according to claim 8, wherein the internal combustion engine comprises a crankcase at least partially enclosing the crankshaft, and wherein the air inlet system comprises an air inlet duct connected to the crankcase, and wherein the throttle valve is arranged in the air inlet duct.

15. The handheld power tool according to claim 8, wherein the internal combustion engine is a crankcase scavenged two-stroke internal combustion engine, and wherein the air inlet system is configured to conduct air to the cylinder at least partially via a crankcase of the internal combustion engine.

16. The handheld power tool according to claim 8, wherein the internal combustion engine comprises a main throttle valve arranged in the air inlet system, wherein the handheld power tool comprises a first handle and a throttle actuator arranged at the first handle, and wherein the throttle actuator is operably connected to the main throttle valve.

17. The handheld power tool according to claim 16, wherein the throttle actuator is operably connected to the main throttle valve via a mechanical connection.

18. The handheld power tool according to claim 8, wherein the internal combustion engine comprises an exhaust system configured to conduct exhaust gas from the cylinder to the surroundings, and wherein the exhaust system comprises a catalytic converter.

19. The handheld power tool according to claim 8, wherein the handheld power tool is a chainsaw or a power cutter.
